(19) United States
(12) Patent Application Publication
(10) Pub. No.: US 2014/0189880 A1
(43) Pub. Date: Jul. 3, 2014

(54) SYSTEM AND METHOD FOR ADMINISTRATING ACCESS CONTROL RULES ON A SECURE ELEMENT

(71) Applicant: GEMALTO SA, Meudon (FR)

(72) Inventor: Oliver Funk, Austin, TX (US)

(21) Appl. No.: 13/731,225

(22) Filed: Dec. 31, 2012

(51) Int. Cl. G06F 21/62

(52) U.S. Cl. CPC G06F 21/62
USPC 726/27

(57) ABSTRACT

System and method for managing access control rules in a multi-application environment. Access control rules are managed in a secure element issuer security domain. When a method invocation attempting access to a rule, a verification is performed to ensure that the calling manager application is located in a security domain corresponding to the access control rule. Other systems and methods are disclosed.

### BACKGROUND OF THE INVENTION

The present invention relates generally to management of access control rules on a secure element, and more particularly to management of access control rules for applications and data on a secure element in an multi-application environment.

In the brief history of mobile communications devices, the devices have quickly evolved from being primarily or even exclusively dedicated to mobile telephone communication to being extraordinarily powerful multi-purpose devices. With recent technical developments it is now possible to use mobile devices, e.g., mobile telephones, for disparate applications such as payment, transportation ticketing, loyalty programs, bank account access, physical access control to buildings or offices, etc. Near Field Communication is an enabling technology that makes these new functions possible on mobile devices.

Security is an import criteria for many these functions; for example, it is often a necessary factor for a successful commercial program to be able to have confidence that mobile transactions are secure and not easily intercepted by attackers wishing to steal information such as account numbers, transaction patterns, personal data, or cryptographic keys used in making the transactions secure. Secure elements such as Universal Integrated Circuit cards (UICC) are components in the mobile devices that are extremely useful in providing security and confidentiality. Secure elements are tamper-resistant electronic security devices that are particularly suited for secure storage of sensitive data such as account numbers, authentication credentials, and cryptographic keys. They also are often used for end-to-end secure communication with a remote site using cryptographic capabilities built into the secure element and to perform cryptographic operations.

Examples of secure elements include UICC, embedded secure elements, secure memory cards, and smart cards.

Clearly, the convenience and power of these devices for the consumer is dependent on being able to use, with dependable security, the same device for many different types of transactions.

Typically, the service providers providing these services are completely unrelated to one another, e.g., one's bank neither provides transportation services nor does it sell gasoline. Yet what they have in common is that they must share space on a secure element in a secure fashion.

GlobalPlatform Inc. (Redwood City, Calif., USA) is an industrial non-profit organization that publishes standards that operate to facilitate deployment of multiple embedded applications on secure elements and facilitates flexible secure solutions involving multiple actors and many different business models. GlobalPlatform 2.2 provides a framework for multiple actors to coexist on a single secure element. GlobalPlatform introduces a central actor known as the Trusted Service Manager in the GlobalPlatform mechanism for managing communications between Mobile Network Operators (MNO) and Service Providers (SP).

Global Platform provides several different secure element configuration scenarios involving the TSMs (GlobalPlatform's Proposition for NFC Mobile: Secure Element Management and Messaging, White Paper, GlobalPlatform Inc., April 2009, http://www*globalplatform*org/documents/GlobalPlatform_NFC_Mobile_White_Paper.pdf,¹ retrieved on Dec. 5, 2012, the entire contents of which is incorporated herein by reference): ¹ To avoid having impermissible functioning hyperlinks in this document, periods (“.”) in urls are replaced with asterisks (“*”). Thus, each asterisk should be replaced with a period when accessing the referenced site.
Simple Mode: an issuer (MNO) centric model, where card content management is only performed by the MNO but is monitored by the TSM
Delegated Mode: card content management can be delegated to a TSM, in which case the MNO must preauthorize operations.
Authorized Mode: TSM is responsible for card content management for a sub-area of the UICC. The sub-area which is associated with the TSM is referred to as the security domain (SD) of the TSM.
   There may be multiple TSMs that may be involved in managing transactions and contents with respect to a particular secure entity. Thus, in Authorized Mode (AM) several entities may perform content management on the secure element.

A typical scenario involving a mobile device and a secure element in GlobalPlatform-deployed mobile transaction system application, e.g., a retail transaction, would involve both a device application executing on the mobile device and a secure element application. These do not necessarily have to be matched one-to-one, e.g., one device application may access multiple SE (Secure Element) applications, and vice versa. Therefore, access control rules are used to manage the access that specific device applications may make to particular contents, e.g., SE applications, of the secure element. Access control rules stored on the secure element specify for a particular SE application, or for all other appropriate SE applications on a given secure element, that the given device application or all other device applications have access rights to specified APDUs (Application Data Units) and specified NFC events. GlobalPlatform Device Technology Secure Element Access Control, Version 1.0, GlobalPlatform Inc., May 2012, http://www*globalplatform*org/specificationsdevice.asp, accessed on Dec. 5, 2012 (entire contents of which is incorporated herein by reference). Because an access control rule may apply not just to an individual application or multiple applications, and because separate rules may be defined in different places on the Secure Element (for example, in the ARA-M and in an ARA-C), access control rules may overlap and conflict with each other, so a method must be defined to determine which rule should supercede the others and thus should be applied. The GlobalPlatform Device Technology Secure Element Access Control document (cited above) describes one such mechanism while maintaining access control rules in a distributed fashion.

From the foregoing it will be apparent that there is still a need for an improved method to provide a flexible, convenient and yet powerful mechanism to administrate secure element access control rules for multiple authorized management actors which administer applications on a shared multi-application secure element.

### BRIEF DESCRIPTION OF THE DRAWINGS

FIG. 1 is a block diagram illustrating the use of a mobile device in a transaction using a near field communications (NFC) terminal.

FIG. 2 is a block diagram illustrating a mobile device of FIG. 1 including a secure element.

FIG. 3 is a schematic illustration of a secure element 201, for example, a UICC.

FIG. 4 is a block diagram illustrating software modules and programs stored in memory of the secure element of FIGS. 2 and 3.

FIG. 5 is a high-level schematic illustrating the Trusted Service Manager (TSM) role in conjunction with Service Providers (SP) and Mobile Network Operators (MNO).

FIG. 6 is a high-level block diagram illustrating the access control architecture of the secure element on the mobile device including TSM SDs.

FIG. 7 illustrates a preferred embodiment for an architecture 701 that allows independent administration of a common access control rule repository by multiple actors.

FIG. 8 illustrates a simple hierarchical relationship which may be used for performing hierarchy checks.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment of the invention, a mechanism is provided for a common access control repository that may be independently administered by multiple actors.

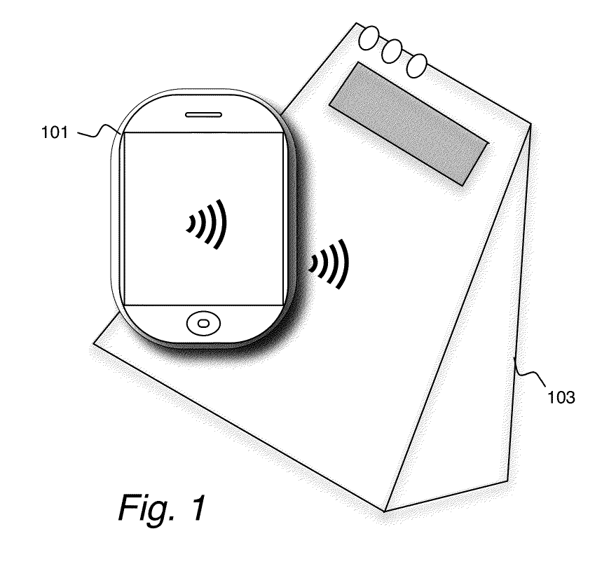

FIG. 1 is a diagram illustrating the use of a mobile device 101 in a transaction using a near field communications (NFC) terminal 103. To engage in a transaction the user of the mobile device 101 places the mobile device 101 near the terminal 103. Applications in the device 101 and in the terminal 103 transfer messages between the device 101 and the terminal 103. These messages may be in the form of communications with other computers either directly connected to the terminal 103 or remotely.

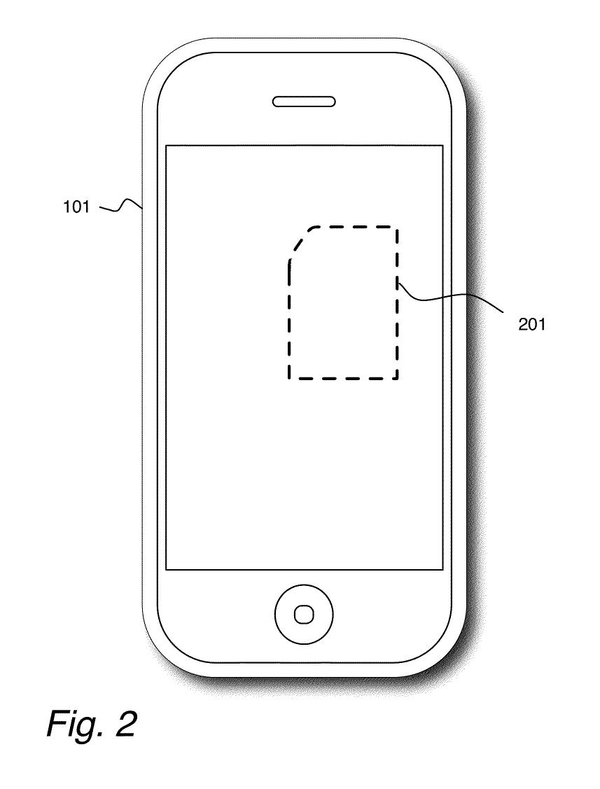

FIG. 2 illustrates that a secure element 201 is a component of the device 101. Applications using NFC for mobile transactions rely on both the device 101 and the secure element 201. The role of the SE 201 applications may be to securely store account numbers and balances, store authentication credentials and perform authentication protocol exchanges on behalf of the user, store cryptographic keys and perform cryptographic operations, etc. Each service provider may have its own device application and secure element applications associated with the service provided by the service provider. For example, a retailer may have a device application for providing a user interface to the user of the device 101 and a secure element application on the secure element 201 for performing particular security functions using NFC on the device 101.

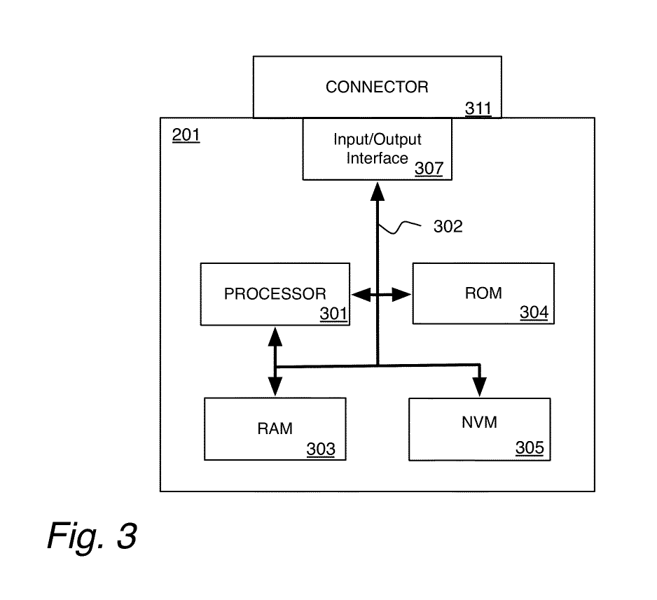

FIG. 3 is a schematic illustration of a secure element 201, for example, a UICC. The secure element 201 may include a processor 301 connected via a bus 302 to a random access memory (RAM) 303, a read-only memory (ROM) 304, and a non-volatile memory (NVM) 305. The secure element 201 further includes an input/output interface 307 for connecting the processor 301, again typically via the bus 302, to a connector 311 by which the portable security device 309 may be connected to the device 101.

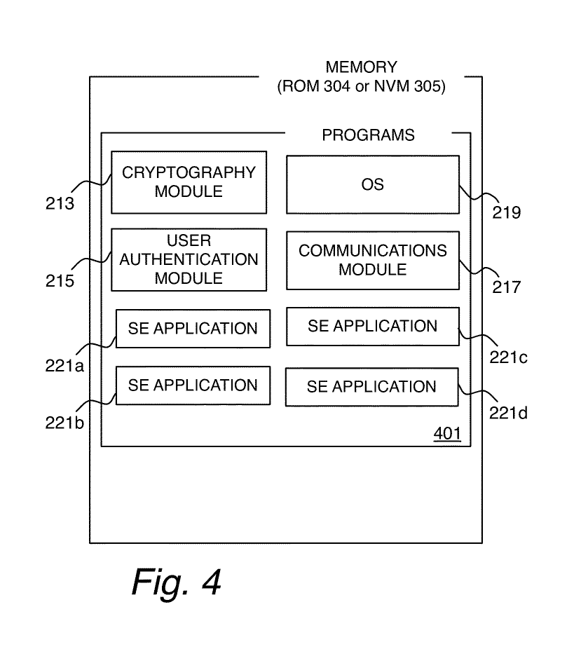

The NVM 305 and/or ROM 304 may include computer programs 401 as is illustrated in FIG. 4. While it is here depicted that the computer programs 401 are all co-located in the ROM 304 or the NVM 305, in actual practice there is no such restriction as programs may be spread out over multiple memories and even temporarily installed in RAM 303. Furthermore, the secure element 201 may include multiple ROMs or NVMs. The programs 401 include operating system programs as well as application programs loaded on to the secure element 201.

The secure element 201 programs 401 may include a cryptography module 213, a user authentication module 215, a communications module 217, and the operating system OS 219. The secure element 201 programs 401 may further include one or more SE applications 221a-221d for causing the secure element 201 to perform the tasks of the secure element 201 associated with mobile transactions.

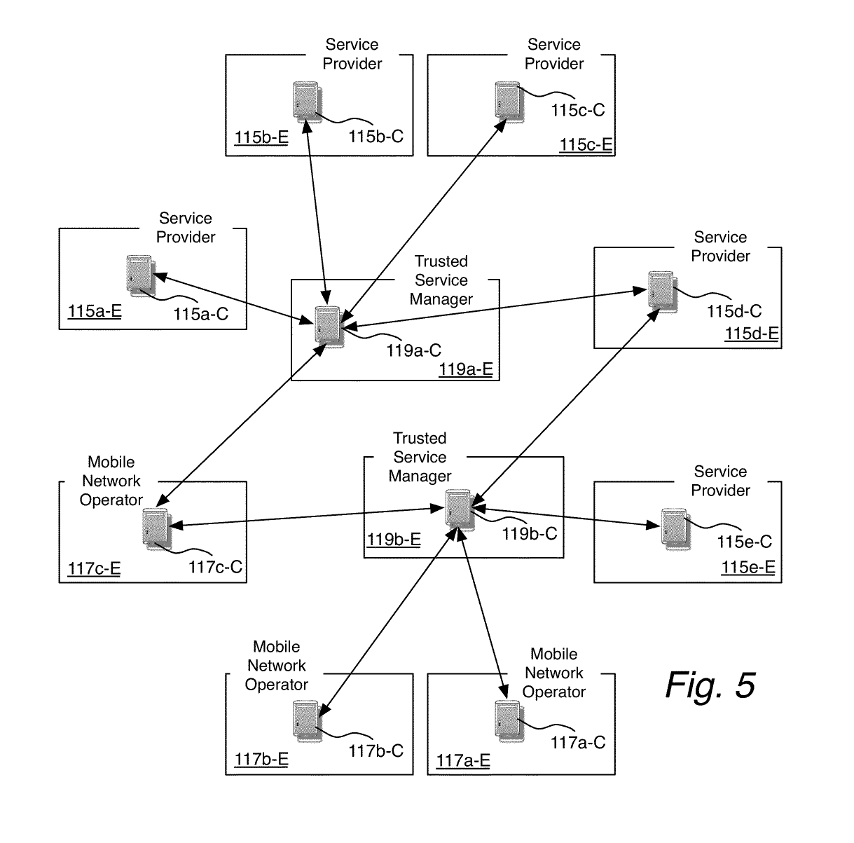

If individual service providers have to interact with each individual mobile network operator for transmission of messages, whether as part of transactions or as part of deployment, chaos would ensue. Therefore, a central actor known as Trusted Service Manager (TSM) is introduced in GlobalPlatform to manage communication between SPs and MNOs. FIG. 5 is a high-level schematic illustrating an example of how the Trusted Service Manager (TSM) might play a role in conjunction with Service Providers (SP) and Mobile Network Operators (MNO). Each TSM 119², which is a combination of computer hardware 119-C and software (not illustrated), establishes a link between service providers (SP) 115 and mobile network operators (MNO) 117. Each TSM may connect multiple MNOs to multiple SPs. Conversely, a given SP 115 or MNO 117 may be connected to either one TSM 119 or multiple TSMs 119. ² In this description several related elements are referred to by n-E, n-C, and n-S, respectively. E stands for entity, C, for computer, and S, for software. Thus, n-E is the entity n-E, that operates the computer n-C, which executes according to instructions n-S. For example, Trusted Service Manager entity 119-E operates a computer 119-C which executes a trusted service manager software. For ease of description, we sometimes refer to these elements by the number n, e.g., TSM 119. Unless the context makes the contrary clear, this should typically be taken to mean as a reference to all three elements performing their respective roles, e.g., that the trusted service manager computer 119-C performs some action prescribed by the software in the trusted service manager software 119-S.

On a given secure element 201 memory allocated for GlobalPlatform applications is administered in secure areas referred to as Security Domains (SD). Security Domains are on-card representatives of off-card authorities. Security Domains (SD) support security services such as key handling, encryption, decryption, digital signature generation and verification for applications of the entities associated with each SD, e.g., the Issuer or Trusted Service Manager. Each SD is established on behalf of a particular actor, e.g., the card issuer (Issuer Security Domain), an application provider (Application Security Domain), or a TSM (TSM SD). SDs are established to isolate keys and other secure information from one actor to other actors and vice versa.

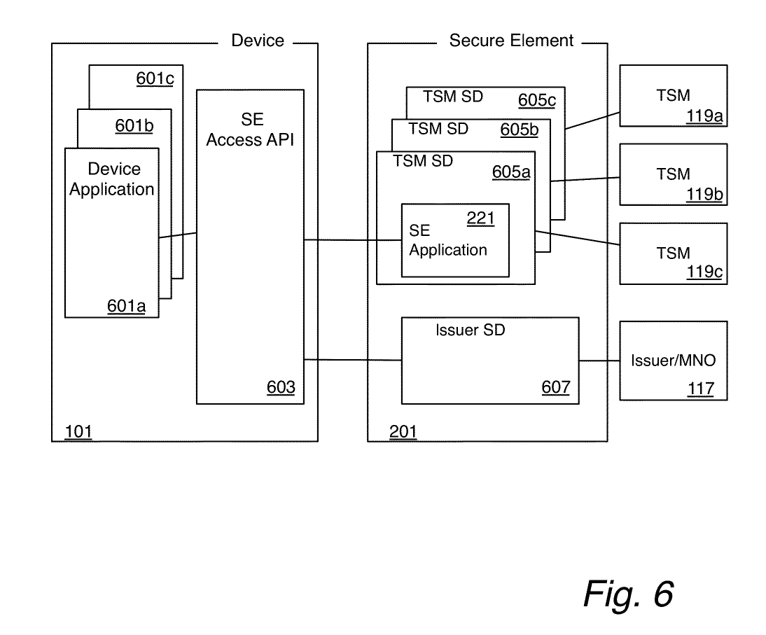

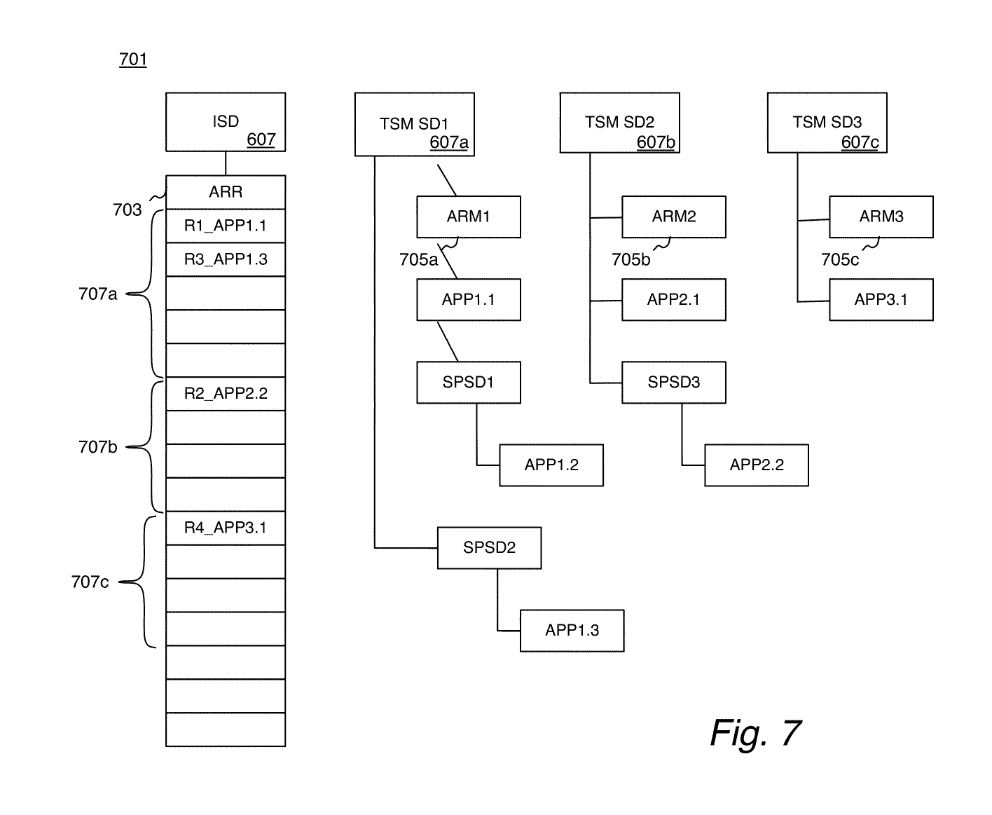

FIG. 6 is a high-level block diagram illustrating the access control architecture of the secure element on the mobile device including TSM SDs. A device 101 has several device applications 601 loaded thereon. The device applications 601 interact with corresponding SE applications 221 on the secure element 201 via an SE Access API 603. Each SE application 221, being deployed by and operating under the control of a TSM 119 is located within a particular TSM SD 605. As will be seen herein below in conjunction with FIG. 7, SE applications may be further located within security domains associated with particular applications (Application Security Domain). Further, a security domain, Issuer Security Domain (Issuer SD) 607 is associated with the issuer of the secure element 201, the issuer typically being a Mobile Network Operator 117.

Access to secure element applications 221 is limited to authorized device applications 601. Access by device applications 601 may be implemented in the operating system of the device 101 based on rules stored in the secure element 201. FIG. 7 illustrates a preferred embodiment for an architecture 701 that allows independent administration of a common access control rule repository by multiple actors. This architecture may be utilized in conjunction with the mechanisms on the device 101, e.g., SE Access API 603, that enforce access control rules.

The architecture 701 has two central components, the Access Rule Repository application (ARR) 703 located in the Issuer SD 607 and an Access Rule Management (ARM) application 705a-705c located within each TSM SC 607, respectively.

In the example of FIG. 7, the ARR 703 has three designated areas 707a-707c for access control rules associated with TSM SD1 607a, TSM SD2 607b, and TSM SD3 607c, respectively. As an example, TSM SD1 607a has within it an SE application APP1.1 which has associated therewith an access control rule R1_APP1.1. Similarly rule R3_APP2.1 is located in an area in ARR 703 and corresponds to TSM SD2 which further corresponds with applications for TSM SD2 607b, and so on. Furthermore, TSM SD1 607a has a Service Provider SD1 and a Service Provider SD2. An application APP1.3 is located within the latter of these, namely, SPSD2. The access control rule for APP1.3, i.e., R3 APP1.3 is located in the access control rule area 707a associated with TSM SD1 607a.

It should be noted that the illustration of FIG. 7 is merely an example. The actual applications, TSMs, service providers, etc., would vary from secure element to secure element depending upon which services a particular user has loaded on her device 101 and secure element 201.

The Access Rules Repository (ARR) application 703 stores all access control rules for the secure element 201 in a common repository. The ARR provides the following functionality:
Allow the device 101 to read all access control rules stored in the ARR 703.
Implement an API that provides methods to ARM applications (see below) to:
   authorize an ARM 705 application
   request adding and removing access control rules
   reserve space for access control rules and free reserved space
Verify that an ARM 705 attempting to manage rules is only managing access control rules for card applications within the hierarchy to which the ARM 705 belongs.

The Access Rules Management Applications (ARM) 705 are added to each GlobalPlatform hierarchy associated with a TSM 607. The ARM applications 705 provide the following functionality:
Allow the TSM 607 associated with the hierarchy to request adding or removing an access rule in the ARR 703. The ARM 705 applications shall only manage access control rules for applications within its corresponding ARR hierarchy, i.e., TSM SD1 607a can only manage access control rules for APP1.1, APP1.2, and APP1.3.
Allow the TSM 607 to request reservation of space to store access rules or free reserved space in the ARR 703.

With respect to the ARR 703, one embodiment of the above functionality may be implemented as follows:
The ARR 703 may be based on a PKCS#15 file structure, e.g., as described herein below.
Write access to the ARR 703 can be optional for personalization but shall be locked in secured state.
In order to ensure that only the creator TSM 607 of an access control rule can request to delete a particular access control rule, the ARR application 703 links an origin ARM 705 Application ID (AID) to every access rule.
The available space for access control rules is managed by the ARR 703 application. The ARR 703 application may provide several pre-configurable policies for granting access rules space to ARM 705 applications. Such policies could be first come, first serve, as well as with or without limit or predefined quota.
The ARR 703 API must be accessible across SD hierarchies. GlobalPlatform GP Global Service is one mechanism for providing the access to the ARR API to SD hierarchies. Global Platform Services are described in GlobalPlatform Card Specification, Version 2.2.1, GlobalPlatform Inc., January 2011, Document Reference: GPC_SPE_{—}034, http://www*globalplatform*org/specificationscard.asp, retrieved on Dec. 5, 2012, hereinafter GP Specification (incorporated herein in its entirety by reference).
The ARR 703 should have Global Registry Privilege to verify the association between an applications access control rule and the requesting TSM SD hierarchy. Global Platform Global Registry is described in the GP Specification. The TSM 605 for a hierarchy 607 provides all hierarchy layers.

With respect to the ARM 705, one embodiment the above functionality may be implemented as follows:
ARM services shall be accessible only via remote applet management (RAM) using the GlobalPlatform Store Data command using specific Tag-Length-Value (TLV) objects as defined by GlobalPlatform for GlobalPlatform messaging.
Granted and used access rules space shall be available by the GlobalPlatform Get Data command using specific TLV objects.

At personalization of the secure element (or at some other early phase in the lifecycle), certain parameter objects, e.g., in tag-length-value (TLV) format, are initialized; these include
Total Slots, set in install parameters
Number of supported ARMs 705
Slot allocation Policy: Mode 1: first come first serve/variable; Mode 2: fixed quota
Slots per ARM: Mode 1: 0 for unlimited or n for max slots; Mode 2: fixed number of slots

The ARR 703 provides API services to the ARMs 705. Examples include the following:
registerARM (rootSDAID)
   The argument rootSDAID is the Application Identifier of the TSM SD of the calling ARM 705.
   The registerARM method is called when the ARM 705 is instantiated.
   The ARR 703 checks that the ARM 705 is indeed associated to the presented root SD.
   The ARR 703 creates an empty list of access control rules and links this list to the ARM 705 using the root SD AID and stores the root SD AID of the ARM 705.
allocSlots(n)
   request allocation of additional slots
   returns the number of added slots
   the behavior depends on the slot allocation policy.
addRule(rule(card application AID, device application Signature), card hierarchy)
   The ARR 703 checks if there is a free slot allocated to the calling ARM 705 (or any free slot in case of Mode 1)
   The ARR 703 checks that calling ARM and card application AID are in the same hierarchy. The ARR 703 uses GPSystem getRegistryEntry method and GPRegistryEntry isAssociated methods to check all levels of the received hierarchy.
   The ARR 703 application assigns a unique rule Id and adds the access rule to the PKCS#15 files system implementation of the ARR 703.
   The rule Id is added to the rules list for this ARM and returned.
removeRule(rule Id)
   The ARR 703 application first checks that the rule id is in the calling ARM's list of access control rules.
   The ARR 703 application removes the access rule from the PKCS#15 files system and updates the rule lists.
deallocSlot(n)
   request de-allocation of slots
   returns number of remaining allocated slots
freeSlots( )
   returns number of free slots for calling ARM
grantedSlots( )
   returns total number of allocated slots for calling ARM

The ARMs 705 are accessible through remote applet management (RAM) using the GlobalPlatform store data and get data methods. When an ARM 705 is instantiated for a particular TSM SD 607, the ARM 705 registers with the ARR using the root SD AID.

In an embodiment, there are a number of tag-length-value (TLV) objects defined and which may be transmitted in messages between the ARR 703, the ARMs 705, and TSM 119. These TLV objects include:
Number of allocated Slots, for get data
Number of free Slots, for get data
Request Slots, only for store data
Add Rule, this Tag is only available for store data and shall contain:
   the access control rules including card application AID and device application signature.
   the hierarchy of SDs between the card Application AID and the AM SD, e.g. for APP1.3 the SP SD.
Rule Id, contains the Rule Id after add
Remove Rule with its Rule Id. For store data

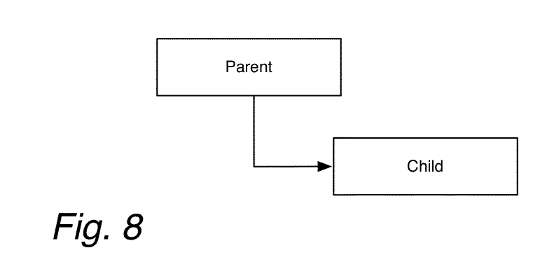

The ARR 703 performs checks to determine that an ARM 705 that is attempting access to a rule is the creator of that rule. This checking depends on the hierarchy structure for a TSM SD 605. FIG. 8 illustrates a simple hierarchical relationship which may be used for performing hierarchy checks.

A call is made to GPSystem.getRegistryEntry (Parent AID) and to the GPRegistryEntry.isAssociated (CHILD AID).

Consider a three-level hierarchy as shown for TSM SD1 607a in FIG. 7. For such a hierarchy there are the following possibilities:
The TSD AID is known from the registerARM(TSD AID)
For APP1 no hierarchy needs to be passed as it is a direct child of the root SD.
For APP2 the TSM needs to pass the SPSD1 AID. The ARR needs to do 2 checks to verify the hierarchy:
   APP2 is child of SPSD1
   SPSD1 is child of TSD
For APP3 the TSM needs to pass both SPSD1 AID and SPSD2 AID. The ARR needs to do 3 checks the hierarchy:
   APP1.3 is child of SPSD2
   SPSD2 is child of SPSD1
   SPSD1 is child of TSM SD1

The foregoing hierarchy checks may be used to confirm that a particular ARM 705 is associated with a particular rule.

From the foregoing it will be apparent that a mechanism has been presented for providing a common repository for access control rules in a structure of independent applications that co-exist on a secure element. Such a mechanism provides a flexible and powerful approach for securely managing access control rules in a multi-application environment.

Although specific embodiments of the invention have been described and illustrated, the invention is not to be limited to the specific forms or arrangements of parts so described and illustrated. The invention is limited only by the claims.

We claim:

1. A method for operating a secure element having a processor and a memory to administer access control rules on a secure element, comprising:
receiving, when the processor is operating according to instructions of an access rule repository application executing in a first security domain, a method invocation attempting to access an access-control rule from an access control manager application associated with a second security domain wherein each access control rule is associated with an application associated with a particular security domain; and
denying access to the access control rule unless the access control manager application is associated with the same security domain as the application associated with the access control rule being accessed.

2. A secure element having a processor and a memory and connectable to a mobile device having a plurality of device applications, wherein the memory comprises:
an issuer security domain having associated therewith
an access rule repository application;
a first trusted service manager security domain having
a first secure element application associated therewith;
a first access control rule manager application;
a second trusted service manager domain having
a second secure element application associated therewith;
a second access control rule manager application;
access control rules structure comprising access control rules authorizing particular device applications to access particular secure applications wherein each access control rule is associated solely with a particular security domain; and
wherein the access rule repository application comprises rule access methods to cause the processor to:
receive a rule-access method method invocation from an access control rule manager application to access a particular access control rule in the access control rules structure; and
upon receiving a rule-access method method invocation, verifying that the particular rule accessed is a rule pertaining to a secure element application associated with the same security domain as the access control rule manager application from which the rule-access method method invocation originates.

3. The secure element of claim 2 wherein the access rule repository application further comprises:
instructions to authorize an access control rule manager application to access and create rules in the access rules repository.

4. The secure element of claim 2 wherein the access rule repository application further comprises:
instructions by which an access control rule manager requests addition or deletion of access control rules.

5. The secure element of claim 2 wherein the access rule repository application further comprises:
instructions to reserve memory space for access control rules and to release reserved memory space.

6. The secure element of claim 2 wherein an access control rule manager application is accessible via the device from a trusted service manager associated with the security domain.

7. The secure element of claim 2 wherein the secure element is issued by an issuer having associated therewith an issuer security domain and the access rules repository resides in the issuer security domain and the access rules repository application executes in the issuer security domain.

8. The secure element of claim 2 wherein an access control rule manager application associated with a particular security domain has associated a unique application identifier (ARM AID) associated therewith and the access rules repository application links the ARM AID of an access control rule manager application with access control rules created by the access control rule manager application.

9. The secure element of claim 2 wherein the secure element is selected from the set including smart card, a trusted module in a smart phone, a trusted module in a computer, a Universal Integrated Circuit Card, a smart memory device.
